(19) United States
(12) Patent Application Publication
(10) Pub. No.: US 2013/0337183 A1
(43) Pub. Date: Dec. 19, 2013

(54) POLYMER COATING SYSTEM FOR IMPROVED TRIBOLOGICAL PERFORMANCE

(71) Applicants: James Economy, Urbana, IL (US); Andreas A. Polycarpou, College Station, TX (US); Jacob Meyer, Urbana, IL (US)

(72) Inventors: James Economy, Urbana, IL (US); Andreas A. Polycarpou, College Station, TX (US); Jacob Meyer, Urbana, IL (US)

(21) Appl. No.: 13/911,845

(22) Filed: Jun. 6, 2013

Related U.S. Application Data
(60) Provisional application No. 61/656,921, filed on Jun. 7, 2012.

(51) Int. Cl. C09D 167/00

(52) U.S. Cl. CPC C09D 167/00
USPC 427/447; 427/180; 427/427.4; 427/430.1; 427/385.5

(57) ABSTRACT

A novel Aromatic Thermosetting Copolyester (ATSP) can be processed into highly effective wear resistant coatings by blending with polytetrafluorethylene (PTFE) and other additives. Surface treatments/coatings are key to improving wear performance and durability in a wide array of applications. The problems associated with use of liquid lubricants, hard/soft coatings are well known but only modest progress has been achieved due to lack of research on new material systems. These coatings were fabricated and tested as highly effective wear resistant coatings by blending ATSP with PTFE and other tribologically beneficial additives. The main advantages of these polymeric-based coatings are their relatively low cost and simple substrate surface conditioning (i.e., no need for expensive surface preparation before coating).

### CROSS-REFERENCE TO RELATED APPLICATIONS

The present application claims the benefit of U.S. Provisional Patent Application No. 61/656,921, filed Jun. 7, 2012, which is hereby incorporated by reference in its entirety.

### STATEMENT OF GOVERNMENT SUPPORT

This invention was made with government support under NSF SBIR Phase I and Phase II awards with contract numbers 1113825 and 1230439, respectively.

### BACKGROUND OF THE INVENTION

Protective thin film coatings ranging in thickness from a few nanometers to several micrometers are used to protect surfaces that are in contact and sliding. These coatings can be found in applications such as magnetic storage hard disk drives, compressors, engines, biological devices and many others. Compressors and similar industrial equipment comprise moving parts that are subject to constant wear and fatigue because of prolonged surface contact and motion. Without protective treatment of the surfaces, equipment that utilizes internally moving parts can suffer from catastrophic failures. Next-generation compressors are being designed to withstand stringent contact and operating conditions, including oil-less or low-lubricant operation. Surface treatments/coatings are key to improving performance and durability for these applications since advanced ultra-low wear and inexpensive coatings would substantially reduce operating costs.

In recent years, great efforts have been made in the formulation of solid lubricants and solid lubricant coatings to achieve desired levels of performance or durability that conventional materials and lubricants cannot provide. Numerous techniques and diverse materials have been used to develop new solid coatings. For simplicity, coatings can be classified into two broad categories—soft coatings (hardness<10 GPa) and hard coatings (hardness>10 GPa). Conventionally, hard coatings such as diamond-like carbon (DLC), Ti—N and WC/C are synthesized through physical vapor deposition (PVD) and chemical vapor deposition (CVD) techniques. These are thought to be effective in preventing both abrasive and adhesive wear of metal sliding contacts. However, hard coatings are relatively expensive and are difficult to coat on substrates with low surface energies, high roughness, and/or complex geometries. They also often wear out the counterface they slide against due to their relatively high hardness.

Due to these concerns with hard coatings, recent attention has focused on soft, thermoplastic-based polymers such as polytetrafluoroethylene (PTFE) and polyether ether ketone (PEEK), which show relatively low friction coefficient and self-lubricating properties. Significant work has been performed with bulk polymeric blends based on PTFE and PEEK for high bearing applications. The main advantages of the polymeric-based coatings are their relatively low cost and simple substrate surface conditioning (i.e., no need for expensive surface preparation before coating). Despite the improvements in wear offered by bulk polymer blends, they are not likely to replace critical components in compressors (and other machinery) since polymeric coatings still exhibit the following problems:

their wear rate is still high (compared to hard coatings);

because they rely heavily on the interaction between the PTFE/PEEK wear debris/solid lubricant and the substrate for surface protection, in the presence of lubricant they may become ineffective;

the addition of hard particles in these mixtures scratches the counterface, thus creating excessive abrasive wear;

the wear debris likely contains hard particles that can damage downstream machinery; and

they often have low glass transition temperatures (T_{g}), which limits the operating temperature.

However, little work has been done on new high bearing polymeric-based coatings that would overcome the shortcomings highlighted above, which are highly desirable in most industrial applications.

### BRIEF SUMMARY OF THE INVENTION

Embodiments of the present invention provide a method for fabricating a tribological coating precursor from aromatic thermosetting copolyesters (ATSP) and applying the coating precursor to a substrate to form a coating on the surface of the substrate.

In an embodiment of the present invention, a coating precursor is fabricated by dissolving ATSP oligomers in a solvent, and the coating precursor is applied to a substrate using a spray coating method. In accordance with such embodiments, ATSP oligomers are produced by reacting ATSP precursor monomers to form an oligomer having a carboxylic acid end group and an oligomer having an acetoxy end group, and curing the oligomers to cause the end groups to react and form crosslinks. A catalyst may be used in such a reaction to decrease the curing temperature.

In another embodiment of the present invention, a coating precursor is fabricated by polymerizing ATSP precursor monomers to form fully or partially cured ATSP powder. The coating precursor may be applied to a substrate using a consolidation and sintering process, or may be applied to a substrate using a thermal or plasma spraying process.

In another embodiment of the present invention, a coating precursor is fabricated by heating ATSP oligomers to produce a melt, and the coating precursor is applied to a substrate using a dip coating method or a wire coating method. In accordance with such embodiments, ATSP oligomers are produced by reacting ATSP precursor monomers to form an oligomer having a carboxylic acid end group and an oligomer having an acetoxy end group, and curing the oligomers to cause the end groups to react and form crosslinks. A catalyst may be used in such a reaction to decrease the curing temperature.

### BRIEF DESCRIPTION OF THE DRAWINGS

FIG. 1 illustrates a typical cure schedule for a spray coating method of coating a substrate with ATSP coating precursors.

FIG. 2A illustrates an ATSP-coated disk coated by a spray coating method. FIG. 2B illustrates a profilometry scan output from the disk of FIG. 2A.

FIG. 3 illustrates the results of scratch experiments conducted on PTFE-coated, PEEK-coated, and ATSP-coated cast-iron disks.

FIGS. 4A through 4D illustrate elastic versus plastic deformation for PTFE-, PEEK-, and ATSP-coated cast-iron disks.

FIG. 5 illustrates the results of scratch experiments conducted on PTFE-, PEEK-, and ATSP-coated cast-iron disks.

FIG. 6A illustrates the appearance of cured ATSP powder according to embodiments of the present invention. FIG. 6B illustrates a scanning electron microscope image of individual particulates of the cured ATSP powder of FIG. 6A.

FIG. 7A illustrates twelve ATSP-coated substrates coated by a thermal spraying method according to embodiments of the present invention, where first order parameters were varied in the coating method for each substrate.

### DETAILED DESCRIPTION OF THE INVENTION

In a first embodiment, the present invention provides a method for fabricating a tribological coating by dissolving aromatic thermosetting polyesters (ATSP) oligomers in a solvent followed by spraying onto a substrate and then curing the coating. This method has yielded excellent results in terms of thickness uniformity, smoothness, adhesion, and tribological properties. In addition, several variations of the ATSP oligomeric recipe are available to further improve the performance and also yield a melt processible system. This would be extremely useful for large-scale production by eliminating the solvent and simplifying the coating fabrication.

Another embodiment of this invention is a method for producing ATSP powders that can be formed into a tribological coating through methods such as hot press sintering or thermal/plasma spray.

The addition of a catalyst has been shown to aid in lowering the reaction temperature needed to either synthesize ATSP powder or cure ATSP oligomers.

Embodiments of the present invention provide methods of forming ATSP copolyesters by reacting precursor monomers. A first precursor monomer is selected from 1,4-phenylene diacetate (HQDA), 1,3-phenylene diacetate (RDA), [1,1′-biphenyl]-4,4′-diyl diacetate, propane-2,2-diylbis(4,1-phenylene)diacetate, sulfonylbis(4,1-phenylene)diacetate (1:1:1:1:1), phenyl acetate, nonane-1,9-diyl diacetate, decane-1,10-diyl diacetate, 4,4′-oxydianiline, benzene-1,4-diamine, and benzene-1,3-diamine. A second precursor monomer is selected from 4-acetoxybenzoic acid (ABA), 3-acetoxybenzoic acid, and 6-acetoxy-2-napthoic acid. A third precursor monomer is selected from trimesic acid (TMA), 1-hydroxypropane-1,2,3-tricarboxylic acid, 3,5-diacetoxybenzoic acid, 5-acetoxyisophthalic acid, [1,1′-biphenyl]-3,3′,5,5′-tetracarboxylic acid, propane-1,2,3-tricarboxylic acid, 2,2-bis(acetoxymethyl)propane-1,3-diyl diacetate, benzene-1,3,5-triyl triacetate, dimethyl 3,3-bis(2-methoxy-2-oxoethyl)pentanedioate, and pyromellitic dianhydride. A fourth precursor monomer is selected from isophthalic acid (IPA), 4,4′-oxydibenzoic acid, [1,1′-biphenyl]-4,4′-dicarboxylic acid, benzoic acid, cyclohexane-1,3-dicarboxylic acid, cyclohexane-1,4-dicarboxylic acid, terephthalic acid, azelaic acid acid, sebacic acid, perfluoroazelaic acid, and perfluorosebacic acid. It is therefore contemplated that embodiments and examples of the invention disclosed herein may be modified in accordance, without limitation.

### EXAMPLE 1

### ATSP/Solvent Spray Coating Technique

### A. Materials and Oligomer Synthesis

The synthesis of a two part oligomeric system, one consisting of carboxylic end groups (hereinafter denoted with the reference character “C” or “C1”) and the other consisting of acetoxy end groups (hereinafter denoted with the reference character “A” or “A1”), is described below. As a first step, hydroquinone diacetate (hereinafter HQDA) was synthesized by acetylation of hydroquinone (hereinafter HQ). In this case, 440 g of HQ was mechanically stirred in 850 mL of acetic anhydride (molar ratio of about 4:8.9) in a cylindrical vessel in an ice-water bath at 10° C. at which point 2-3 drops of sulfuric acid was added to catalyze the acetylation reaction. The solution temperature immediately increased to 80-85° C. due to the exothermic reaction. After allowing the solution to cool to room temperature, HQDA was precipitated out with distilled water. HQDA was then filtered, washed with water and dried in a vacuum oven at 70° C. for 12 hours. The reaction yield was above 98%. 4-acetoxybenzoic acid (hereinafter ABA) was produced in a manner analogous to HQDA with a molar ratio of 4:8.7 of 4-hydroxybenzoic acid (hereinafter HBA) mechanically stirred in a large excess of acetic anhydride at room temperature. Upon addition of 2-3 drops of sulfuric acid the temperature increased to 45° C. After allowing the solution to cool to room temperature, ABA was precipitated out with distilled water. ABA was then filtered, washed with water and dried in a vacuum oven at 70° C. for 12 hours. The reaction yield was above 95%.

The other monomers trimesic acid (hereinafter TMA) and isophthalic acid (hereinafter IPA) were purchased from Alfa-Aesar and used without modification. It should be noted that this invention is not limited to the starting materials given in the examples, but is intended to include other monomers that would be obvious to one skilled in the art (e.g., terephthalic acid or oxydibenzoic acid could be used in place of isophthalic acid).

To produce carboxylic acid end-capped oligomer C1, 126 g TMA, 236.8 g HQDA, 149.4 g IPA, and 324 g ABA were mixed in a 2 L reactor flask. The flask was equipped with a three-neck head containing inlets for inert gas, a mechanical stirring bar, and a thermometer. The reactor was continuously purged with argon while immersed in a metal salt bath. The reactor was heated to 260° C. for 15 min to obtain a low-viscosity melt after which stirring was initiated. After refluxing for 1 h, the reflux condenser was replaced with a distillation condenser and collector flask. The temperature was increased to 280-285° C. while continuously stirring the melt. Acetic acid evolved as the reaction byproduct. The extent of the reaction was monitored by the amount of acetic acid collected. After an additional 3 h at 260° C., the reaction was stopped with 232 mL of acetic acid collected (theoretical 242 mL). Reaction yield of the C1 oligomer was about 560 g (approximately 97%). The C1 oligomer product, a translucent, viscous melt, was ground into a fine powder and purified by Soxhlet extraction in a 3:1 methanol-water solution followed by a distilled water rinse and drying overnight at 80° C. in vacuum.

For the acetoxy end-capped oligomer A1, 126 g TMA, 108 g ABA, 432.4 g HQDA and 99.6 g of IPA was used with the same procedure as above. 205 mL of acetic acid was collected after 3 hours at 260° C. (theoretical 208 mL) and reaction yield of the A1 oligomer was about 527 g (approximately 98%). Differential scanning calorimetry (DSC) was used to confirm that both oligomers were of good quality. On curing, the end groups of the oligomers react to form crosslinked ATSP.

For the carboxylic acid end-capped oligomer C2, 42 g TMA, 155.2 g HQDA, 132.8 g IPA, and 216 g ABA was used with same procedure as above. 150 mL of acetic acid was collected after 3 hours at 260° C. (theoretical 160 mL) and reaction yield of the C2 oligomer was about 378 g (approximately 96%). The C2 oligomer product, an opaque, viscous melt, was ground into a fine powder and purified by Soxhlet extraction in a 3:1 methanol-water solution followed by a distilled water rinse and drying overnight at 80° C. in vacuum.

For the acetoxy end-capped oligomer A2, 42 g TMA, 194.2 g HQDA, 66.5 g IPA, and 99.6 g of ABA was used with the same procedure as above. 140 mL of acetic acid was collected after 3 hours at 260° C. (theoretical 144 mL) and reaction yield of the A2 oligomer was about 259 g (approximately 98%). DSC was used to confirm that both oligomers were of good quality. On curing, the end groups of the oligomers react to form crosslinked ATSP.

### B. Catalyst Assisted Curing

The carboxylic acid and acetoxy oligomers (C1:A1 or C2:A2 at 1.1:1 weight ratio) were mixed with 0 to 2.5 wt % sodium acetate (CH₃COONa) as a catalyst. Blends were placed in hermetically sealed pans and analyzed with a TA Instruments 2910 Differential Scanning calorimeter. Changes in curing temperature are described by shifts in the change in heat flow characteristic of the cure reaction with regards to the onset of cure (Tₒ) and the peak cure temperature (Tₚ). Results are shown in Table 1 indicating that sodium acetate is effective for decreasing the cure temperature.

TABLE 1
Onset and peak cure temperatures for catalyst
assisted curing of ATSP oligomers.

| | C1A1 | | C2A2 | |
|---|---|---|---|---|
| CH₃COONa (wt %) | Tₒ (° C.) | Tₚ (° C.) | Tₒ (° C.) | Tₚ (° C.) |
| 0 | 264.4 | 313.2 | 248.1 | 297.5 |
| 0.15 | 262.8 | 302.2 | 242.6 | 285.4 |
| 0.3 | 257.9 | 286.8 | 233.8 | 270.1 |
| 0.6 | 257.6 | 285.0 | 229.1 | 263.9 |
| 1.22 | 247.9 | 276.8 | 220.7 | 255.3 |
| 2.5 | 235.6 | 271.7 | 214.7 | 246.2 |

### C. Spray Coating Method

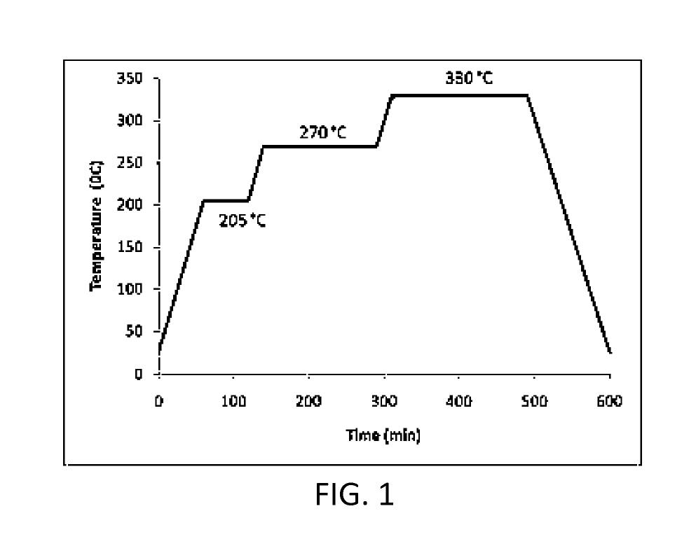

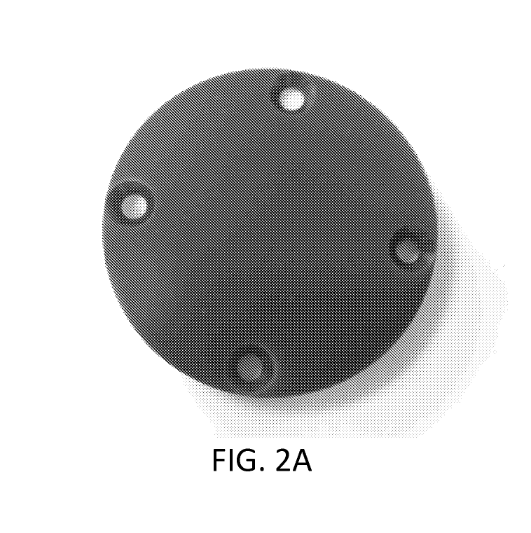

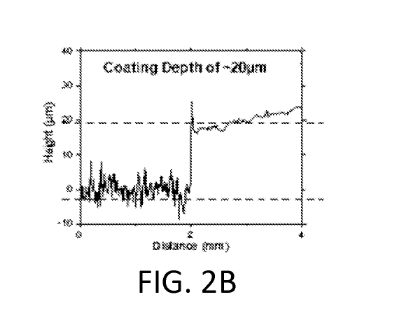

The carboxylic acid and acetoxy oligomers (C1:A1 or C2:A2 at 1.1:1 weight ratio) were mixed with N-methylpyrrolidinone (NMP) at concentrations between 0.15-0.35 g of oligomers per mL of solvent, along with lubricating or hardening additives (e.g., PTFE, polyimide, graphite, mullite, or MoS₂ powders), and held in stirred suspension at 80° C. A technique compatible with commercial wet spray processes utilizing compressed air was developed and the oligomeric solutions were applied to roughened cast iron substrates to form a coating film over the surface of the substrates. The solvent was then evaporated away at 202° C. and the coating film was cured in vacuum at 330° C. FIG. 1 illustrates a representative cure cycle for this process in a vacuum oven. Note that curing can also be performed in forced air or forced inert gas at cure times as low as 20 minutes at 240° C. by use of finely divided sodium acetate as a catalyst as described above. Sodium acetate can be introduced into the oligomer solution and co-sprayed along with the oligomeric constituents. This technique was found to be functionally insensitive to both inorganic and PTFE additive concentration. Inorganic lubricating additives with particle diameters less than 40 μm such as graphite, molybdenum disulfide (MoS₂), boron nitride (BN), and carbon black were added to stirred oligomer solutions to concentrations ranging from 1 wt % to 25 wt % of oligomer mass in solution, were sprayable, and produced low roughness coatings after curing as above. Perfluorinated lubricating additives such as polytetrafluroethylene (PTFE), perflororoalkoxy (PFA), and fluorinated ethylene propylene (FEP) with particle diameters of less than 20 μm were likewise added into stirred suspension in oligomer solutions to concentrations ranging from 1 wt % to 15 wt % of oligomer mass in solution. Note that ATSP is not water soluble, however NMP has several desirable properties such as low volatility, low flammability and relatively low toxicity and is already being used as a solvent to apply commercial polymeric wear coatings (Thus its potential environmental impact is similar or better than existing commercial coatings). FIG. 2A shows an image of a spray-coated disk coated with a film with a thickness of 20 microns, as indicated by the profilometry scan output for the disk illustrated in FIG. 2B. The ATSP coatings can be consistently produced in a 20-40 microns range with ˜5 micron standard deviation, a typical sample roughness is 0.4±0.15 microns.

In addition, ATSP exhibits very good adhesion to different metal substrate surfaces. For example, in peel strength experiments on copper, copper sputtered with zinc and copper sputtered with nickel surfaces, it was found that the peel strength of ATSP coatings on copper sputtered with zinc was about three times the peel strength of ATSP coatings on nickel and copper surfaces. In other tests, the lap shear strength of ATSP coatings on different kinds of titanium surfaces was examined and the results showed that ATSP coatings have adhesion strength of 2000-3000 psi on titanium surfaces, which is comparable to the strength of epoxy on metal surfaces. So it is believed that the poor adhesion problem for some coatings does not exist for the ATSP coating on metal surfaces.

### D. Tribological Data

Tribotesting was performed using a High Pressure Tribometer (HPT) under wear conditions that simulate an aggressive air-conditioning scroll compressor (summarized in Table 2). It was found in the past that the results from the HPT correlate well with field data performed by industry. The spray coated cast iron substrates were tested under two conditions:

(I) unidirectional high speed sliding conditions, typical of the scroll component contact, and

(II) small oscillation fretting motions, simulating the thrust bearing in the compressor.

In both cases, constant load wear type experiments were performed to determine the wear rate and coefficient of friction (COF), as compared to scuffing load (stepping up the load) experiments to determine the threshold to catastrophic failure.

TABLE 2
Experimental tribological conditions simulating
aggressive compressor conditions.

| Conditions | I: Unidirectional | II: Fretting |
|---|---|---|
| Sliding speed (m/s) | 4.0 | 4.5 Hz oscillation, |
| | | 1.5 mm translation, |
| | | 13.5 mm/s |
| Normal load (N) | 445 | 445 |
| Pin type | 10 mm compressor shoe | 3.2 mm Cl pin |
| Test duration (min) | 30 | 30 |
| Chamber temperature | 90 | 90 |
| (° C.) | | |

The ATSP C1A1 and C2A2 coatings performed well under unidirectional conditions and the COF was very stable and consistent (Table 3). In several cases, the unidirectional results are on par with state-of-the-art commercially available coatings (Table 4). And in a recent extended duration testing of 3 hours (simulating durability or life experiments), the wear rate for C2A2 coatings declined significantly and maintained a shallow 15 μm wear track, indicating it had reached a steady state.

TABLE 3
COF and wear data for various ATSP spray coated
disks under unidirectional conditions.

| | Duration of | | Wear Depth | Wear Rate |
|---|---|---|---|---|
| Coating | Test (min) | COF | (μm) | (mm³/[N*m]) |
| C1A1 | 30 | 0.04 | 14 | 5.45E−6 |
| 5 wt % PTFE | 30 | 0.02 | 13 | 4.45E−6 |
| C1A1 | 30 | 0.05 | 13 | 2.70E−6 |
| 5 wt % MoS₂ | | | | |
| C2A2 | 30 | 0.08 | 17 | 2.82E−6 |
| 5 wt % PTFE | 30 | 0.07 | 6 | 8.93E−7 |
| | 30 | 0.07 | 10 | 9.03E−7 |
| | 116 | 0.08 | 5 | 2.12E−7 |
| | 180 | 0.09 | 15 | 8.09E−7 |

TABLE 4
COF and wear data for various commercial polymeric
coated disks under unidirectional conditions.

| | Duration of | | Wear Rate |
|---|---|---|---|
| Coating | Test (min) | COF | (mm³/[N*m]) |
| DuPont ® 958-303 | 30 | 0.05 | 1.54E−6 |
| (PTFE/Resin) | | | |
| DuPont ® 958-414 | 30 | 0.04 | 1.23E−6 |
| (PTFE/Resin) | 180 | 0.05 | 2.70E−7 |
| Fluorolon ® 325 | 30 | 0.04 | 3.76E−7 |
| (PTFE/MoS₂) | 180 | 0.13 | 1.15E−6 |
| 1704 PEEK/PTFE | 30 | 0.08 | 1.63E−5 |
| 1707 PEEK/Ceramic | 30 | 0.09 | 6.73E−6 |

The C1A1 and all commercial coatings failed before the full duration of the fretting test with much deeper wear tracks (Table 5). However, ATSP's low crosslink density formulation (C2A2 with 5 wt % PTFE) survived the 30-minute test with low COF values and relatively shallow wear tracks. When subjected to a 3-hour durability test, the ATSP-based coatings again survived where commercial coatings based on PEEK and PTFE did not.

TABLE 5
COF and wear data for various ATSP spray
coated disks under fretting conditions.

| | Duration of | | Wear Depth | Wear Rate |
|---|---|---|---|---|
| Coating | Test (min) | COF | (μm) | (mm³/[N*m]) |
| C1A1 | 23 | 0.14 | 55 | N/A |
| 5 wt % PTFE | 29.5 | 0.14 | Deep | N/A |
| C1A1 | 2 | 0.20 | 40 | N/A |
| 5 wt % MoS₂ | | | | |
| C2A2 | 30 | 0.10 | 10 | 5.65E−4 |
| 5 wt % PTFE | 30 | 0.09 | 10 | 5.02E−4 |
| | 30 | 0.09 | 8 | 1.50E−4 |
| | 30 | 0.08 | 15 | 3.00E−4 |
| | 180 | 0.09 | 30 | 9.48E−5 |

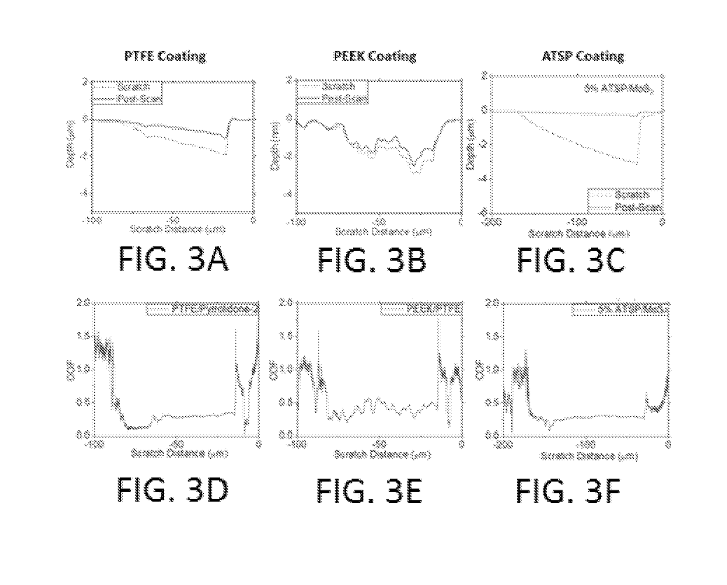

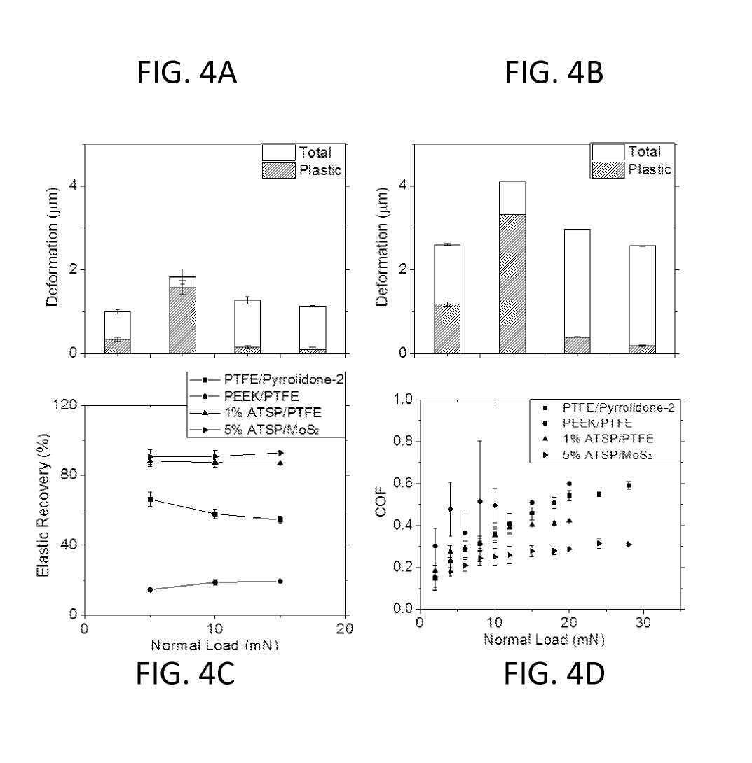

ATSP coatings on cast iron substrates were additionally observed to evidence an extraordinarily high degree of elastic recovery as compared to state-of-art polymeric coatings. Polymer-coated cast iron substrates were scratched by a 4.3 μm conispherical indenter tip at a ramp rate of 2 mN/s and a translation speed of 10 μm/s in a Hysitron TI-950 Triboindenter. FIG. 3 illustrates the results of these scratch experiments performed on PTFE-coated, PEEK-coated, and ATSP-coated disks. Experiments to 5 and 15 mN were carried out followed by a retrace along the scratch path to identify elastic versus plastic deformation. Post-scan trace was carried out at 0.2 mN to determine the elastically recovered profile. FIGS. 4A and 4B illustrate total plastic versus elastic deformation at a maximum load of 5 mN and 15 mN, respectively; FIG. 4C illustrates percent elastic recovery as a function of maximum load; and FIG. 4D illustrates the COF during this process. ATSP coatings demonstrated an almost complete elastic recovery when compared to other commercially available polymeric coatings while still retaining a low and stable COF. Note that polymers with better elastic recovery display better frictional behavior due the smaller real contact area.

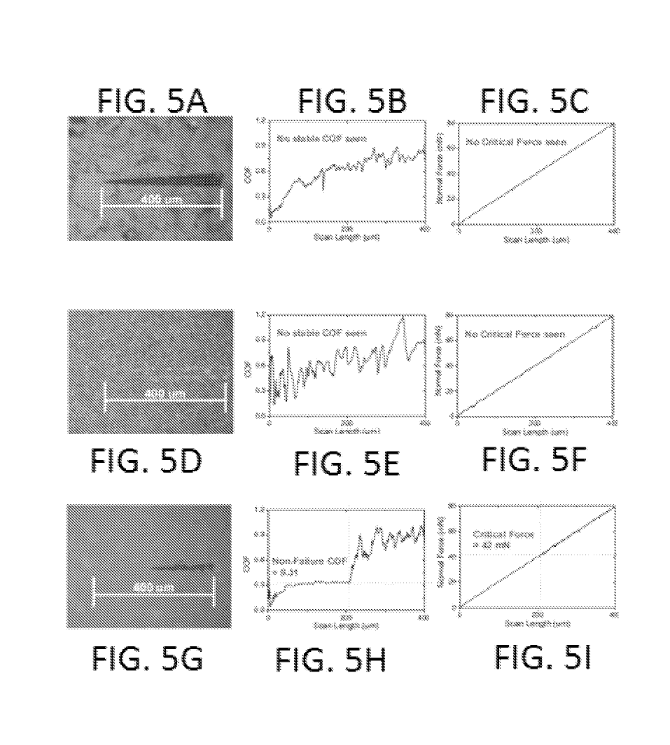

ATSP-based coatings in scratch experiments carried to normal loads of 80 mN while maintaining the above translation and ramp parameters, as illustrated in FIG. 5, evidenced a clear regime below a certain critical force wherein nearly complete elastic recovery is observed.

### EXAMPLE 2

### ATSP Powder-Based Coatings

### A. Materials and ATSP Powder Synthesis

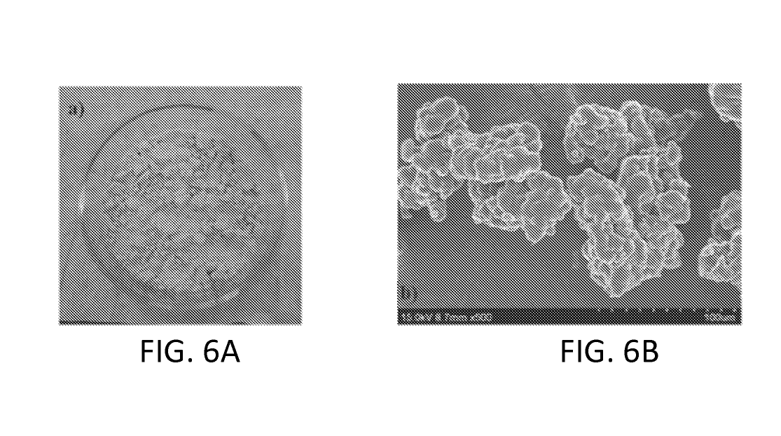

To synthesize cured ATSP powders, TMA, HQDA, IPA, and ABA (molar ratio of 4:11:5:8 respectively) was charged into a 3-neck reactor with Therminol-66 at concentrations between 0.10 and 0.35 kg/L, and was continuously purged with nitrogen. The monomer mixture was stirred using mechanical stirring during the reaction. The monomers were then refluxed at 270-285° C. for 30 min. The apparatus was switched to acetic acid removal and the temperature increased to 270° C. The reaction was carried out at this temperature until 90% of the theoretical yield of the by-product (acetic acid) was captured. The temperature was increased to 320-330° C. for the final 5 hrs. The reaction product was then filtered and washed with acetone and then finally purified using Soxhlet extraction with acetone for 24 hours. FIG. 6A shows a photograph of the ATSP powder material and FIG. 6B shows a scanning electron microscopy (SEM) image of the resulting particulates, whereby the size distribution can be controlled by such factors as the stir speed, monomer concentration, etc.

A process for producing partially cured ATSP powders was carried out as above except that the reaction was carried out to only 35% degree of by-product acetic acid removal. The reaction product was then filtered and washed with acetone and then finally purified using Soxhlet extraction with acetone for 24 hours.

A lower temperature cure process was achieved by utilizing sodium acetate as a catalyst for transesterification. TMA, HQDA, IPA, and ABA (molar ratio of 4:11:5:8 respectively) and 2.5 wt % sodium acetate was charged into a 3-neck reactor with Therminol-66, which was continuously purged with nitrogen. The monomers were refluxed for 60 min and the apparatus was switched to acetic acid removal. The reaction was carried out at this temperature until 45% of the theoretical yield of the by-product (acetic acid) was captured. The reaction product was then filtered and washed with acetone and then finally purified using Soxhlet extraction with acetone and ethanol for 24 hours. The powder was then subjected to a heating cycle intended to promote a solid-state ITR process to produce a fully cured powder. ATSP powder was heated to 330° C. under vacuum for 4 hours and removed. Themogravimetric analysis (TGA) demonstrates a much lower degree of off-gassing for ATSP cured product through 500° C.

### B. Compression Sintered Coatings

One route to produce coatings from ATSP powder is to utilize consolidation and sintering by application of heat and pressure. Fully cured ATSP powder as produced above was mechanically blended with lubricating additives such as with particle diameters less than 40 μm such as graphite, molybdenum disulfide (MoS₂), boron nitride (BN), and carbon black as well as perfluorinated lubricating additives such as polytetrafluroethylene (PTFE), perflororoalkoxy (PFA), and fluorinated ethylene propylene (FEP) with particle diameters of less than 20 μm at a weight ratio of 19:1. This was then evenly deposited onto a roughened aluminum substrate to form a coating film, and heated to 330° C. for 4 hours and 0.7 MPa pressure applied via a Carver hot press.

### C. Thermal/Plasma Spray Coatings

Another method for producing ATSP coatings is through the use of thermal/plasma spray techniques. Partially cured ATSP powder was initially passed through a ˜60 mesh sieve to remove any large polymer particles. The powder was then loaded into the Twin 10 feeder hopper with a Eutectic Terodyn 3000 combustion spray gun used for these trials. An initial set of parameters was chosen based on prior experience with depositing liquid crystal polymer powders:

Spray Distance: 3 inches

Air Back Pressure: 60 psi

Acetylene pressure/flow: 15 psi/15 FMR

Oxygen pressure/flow 50 psi/13 FMR

Argon Carrier pressure/flow: 4 bar/10 FMR

Traverse Rate: 100% (2 inches/sec)

The first two samples in Table 6 were for the purpose of generating splats. However, very little in-flight melting occurred and the substrate pre-heat temperature was insufficient to promote splatting. Attention was then focused on generating coatings whereby additional passes of the spray torch are needed to heat the polymer during deposition. The following parameters were chosen and then varied as shown in Table 6 to influence flame temperature, particle velocity, and substrate temperature. High carrier flow rates were also used to create high shear upon impact. Temperatures of the deposited coating were recorded using an infrared pyrometer with emissivity set to 0.95.

TABLE 6
Partially cured ATSP sample summary (combustion spraying).

| | Pre- | Air | | Powder | | | |
|---|---|---|---|---|---|---|---|
| Sample | Heat | Shroud | | Wheel | Coating | Thickness | |
| Number | (° F.) | (psi) | Cycles | RPM % | Temp (° F.) | (mils) | Comment |
| 0923-01 | 110 | 60 | 1 | 5 | NA. | Splats | No splats |
| 0923-02 | 270 | 60 | 1 | 5 | NA. | Splats | No splats |
| 0923-03 | 250 | 60 | 3 | 30 | 450 | 10 | Poor melting |
| 0923-04 | 325 | 60 | 2 | 30 | 550 | 7 | Some melting |
| 0923-05 | 320 | 50 | 2 | 30 | 420 | 6.5 | Poor melting |
| 0923-06 | 320 | 45 | 2 | 30 | 500 | 6 | Poor melting |
| 0923-07 | 450 | 45 | 1 | 30 | 520 | 3 | 150% Traverse |
| | | | | | | | Speed. Some |
| | | | | | | | Melting |
| 0923-08 | 450 | 45 | 3 | 30 | 520 | 7 | 150% traverse. |
| 0923-09 | 550 | 45 | 2 | 30 | 600 | 5.5 | Some melting |
| 0923-10 | 550 | 20 | 1 | 30 | >600 | 2 | Degraded |
| 0923-11 | 650 | None | 1 | 30 | 380 | 1.5 | No Flame - |
| | | | | | | | Powder Only. |
| | | | | | | | Coating is |
| | | | | | | | WHITE. Post- |
| | | | | | | | heated to 450 F, |
| | | | | | | | coating turned |
| | | | | | | | BLACK |
| 0923-12 | 600 | 50 | 2 | 30 | 580 | 5 | Some Melting |

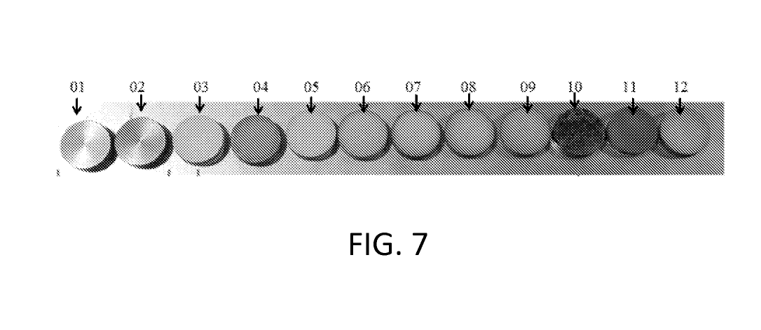

The partially cured ATSP did not exhibit melt flow behavior like a traditional thermoplastic polymer. Coatings were not completely coalesced although some particle melting was observed under a stereomicroscope. At low temperatures (clear coatings), the ATSP powder does not melt uniformly, leading to a coating that is not fully reacted. The polymer is sensitive to thermal-oxidation as witnessed by the discoloration at coating temperatures above 500° F. It was difficult preheating the substrate to temps above 450° F. and keeping the substrate at that temperature just prior to deposition due to substrate cooling effects. These first order parameters produced a wide variety of results, indicating that they are indeed the critical parameters to optimize, and also providing a processing window to be further refined. FIG. 7 shows the appearances of the 12 substrates after thermal spraying, arranged from left to right in the order of Table 6.

A low temperature flame may be utilized in the thermal spraying process to prevent degradation to the polymer in conjunction with using a better, higher temperature heater assembly that can heat and insulate the substrate to temperatures of 600 F or greater. Improved particle melting and coalescence may result. The properties of the ATSP polymer such as molecular weight, and crosslink density may be modified such that the polymer may exhibit greater melt flow behavior. Improved particle melting and coalescence may result by decreasing the melting temperature (i.e. a greater processing window between melting temperature and onset of degradation).

### EXAMPLE 3

### ATSP Melt Processible Oligomers and Coatings

### A. Oligomer Synthesis

For the carboxylic acid end-capped oligomer C8, 42 g TMA, 46.6 g HQDA, 39.9 g IPA, and 129.7 g ABA was used with same procedure as above. 64 mL of acetic acid was collected after 3 hours at 260° C. (theoretical 68.6 mL) and reaction yield of the C8 oligomer was about 180 g (approximately 97%). The C8 oligomer product, a translucent, viscous melt, was ground into a fine powder and purified by Soxhlet extraction in a 3:1 methanol-water solution followed by a distilled water rinse and drying overnight at 80° C. in vacuum.

For the linear acetoxy end-capped oligomer A-M, 40 g of IPA and 93.4 g of RDA was used in the same procedure as above. Resorcinol diacetate (hereinafter RDA) was produced via an analogous process to HQDA from resorcinol. The same mole, mass ratio, catalyst, and temperature conditions were used for the synthesis of RDA as HQDA. The purification of RDA however was carried out via distillation under vacuum to 26 inHg and 100° C. The reaction yield was above 98%.

26 ml, of acetic acid was collected after 1 hour at 260° C. (theoretical 27.4) and reaction yield of the A-M oligomer was about 100 g (approximately 96%). The A-M oligomer product was an opaque, low viscosity melt that retained flow even to room temperature. DSC and NMR were used to confirm that both oligomers were of good quality. On curing, the end groups of the oligomers react to form crosslinked ATSP.

### B. Dip Coatings

An ATSP oligomer melt was produced by heating A-M and C8 oligomers in a 1.2:2.2 weight ratio to 120° C. with mechanical stirring. At this point, the oligomer formulation evidenced a viscosity less than 400 cP as measured by a spindle-type viscometer. A roughened aluminum coupon was submerged in the melt and withdrawn. The coupon was subsequently cured at 330° C., producing a well adhered 100 μm coating film. Note that this process obviates the use of a solvent to lower viscosity and therefore thickness of deposited oligomer can be controlled via the temperature, i.e., higher temperature yields a less viscous melt producing a thinner coating. At 150° C., the viscosity was less than 320 cP and this higher temperature melt produced a deposited oligomer layer film which was subsequently cured to 70 μm in thickness.

### C. Wire Coatings

This process is applicable to wires drawn through the melt, with an aperture of desired radius serving to control wire coating thickness and subsequently drawn through a heating zone at 330° C. to produce a uniform, high temperature stable wire coating. An ATSP oligomer melt was produced by heating A-M and C8 oligomers in a 1.2:2.2 weight ratio to 120° C. with mechanical stirring. At this point, the oligomer formulation evidenced a viscosity less than 400 cP as measured by a spindle-type viscometer.

Necessary times and temperatures to produce a non-brittle coating of ATSP was adjusted by use of finely divided sodium acetate catalyst introduced into the melt at a concentration of up 1 wt % of the oligomer mass. Heating zone temperature could be reduced to 270° C. from 330° C.

Lubricating additives such as with particle diameters less than 40 μm such as graphite, molybdenum disulfide (MoS₂), boron nitride (BN), and carbon black as well as perfluorinated lubricating additives such as polytetrafluroethylene (PTFE), perflororoalkoxy (PFA), and fluorinated ethylene propylene (FEP) with particle diameters of less than 20 μm were added to stirred oligomer melts and demonstrated uniform and low roughness coatings.

While particular elements, embodiments, and applications of the present invention have been shown and described, it is understood that the invention is not limited thereto because modifications may be made by those skilled in the art, particularly in light of the foregoing teaching. It is therefore contemplated by the appended claims to cover such modifications and incorporate those features which come within the spirit and scope of the invention.

I claim:

1. A method of preparing an coating for use in tribological applications, comprising:
preparing a coating precursor comprising an aromatic thermosetting copolyester; and
applying the coating precursor onto a surface of a substrate to form a coating on the surface of the substrate.

2. The method of claim 1, wherein the aromatic thermosetting copolyester comprises an oligomer having a carboxylic end group with an oligomer having an acetoxy end group, where at least one of the oligomers has more than two of said end group.

3. The method of claim 2, wherein the oligomer having a carboxylic end group and the oligomer having an acetoxy end group are crosslinked by curing in the presence of a catalyst.

4. The method of claim 1, wherein the crosslinked aromatic polyester comprises a first monomer chosen from the group consisting of 1,4-phenylene diacetate, 1,3-phenylene diacetate, [1,1′-biphenyl]-4,4′-diyl diacetate, propane-2,2-diylbis(4,1-phenylene)diacetate, sulfonylbis(4,1-phenylene)diacetate (1:1:1:1:1), phenyl acetate, nonane-1,9-diyl diacetate, decane-1,10-diyl diacetate, 4,4′-oxydianiline, benzene-1,4-diamine, and benzene-1,3-diamine, and a second monomer chosen from the ground consisting of 4-acetoxybenzoic acid, 3-acetoxybenzoic acid, and 6-acetoxy-2-napthoic acid.

5. The method of claim 4, wherein the crosslinked aromatic polyester is formed in the presence of a catalyst.

6. The method of claim 1, wherein the coating precursor comprises the aromatic thermosetting copolyester dissolved in a solvent.

7. The method of claim 6, wherein the solvent is N-methylpyrrolidinone.

8. The method of claim 1, wherein the coating precursor comprises the aromatic thermosetting copolyester in powder form.

9. The method of claim 1, wherein the coating precursor comprises a melt of the aromatic thermosetting copolyester.

10. The method of claim 1, wherein the coating precursor further comprises a lubricating additive.

11. The method of claim 9, wherein the lubricating additive is PTFE.

12. The method of claim 1, wherein the coating precursor is applied onto the surface of the substrate by a wet spraying process.

13. The method of claim 1, wherein the coating precursor is applied onto the surface of the substrate by compression sintering the coating precursor and depositing the coating precursor onto the substrate.

14. The method of claim 1, wherein the coating precursor is applied onto the surface of the substrate by a thermal spraying process.

15. The method of claim 1, wherein the coating precursor is applied onto the surface of the substrate by dipping the substrate in a melt of the aromatic thermosetting copolyester.

16. The method of claim 1, further comprising curing the coating on the surface of the substrate.

17. The method of claim 1, wherein the substrate is a metal chosen from the group consisting of iron, copper, titanium, stainless steel, and aluminum.
